(19) United States
(12) Patent Application Publication
(10) Pub. No.: US 2011/0085024 A1
(43) Pub. Date: Apr. 14, 2011

(54) 3D MULTIVIEW DISPLAY

(75) Inventor: Takaaki Ota, San Diego, CA (US)

(73) Assignee: SONY CORPORATION, A JAPANESE CORPORATION, Tokyo (JP)

(21) Appl. No.: 12/873,077

(22) Filed: Aug. 31, 2010

Related U.S. Application Data
(60) Provisional application No. 61/251,052, filed on Oct. 13, 2009.

(51) Int. Cl. H04N 13/00

(52) U.S. Cl. 348/43; 348/E13.001

(57) ABSTRACT

A method for displaying content to a user including receiving a first content and a second content, applying a first depth to the first content, applying a second depth to the second content and compositing the first content and the second content to generate a 3-Dimensional (3-D) composite content, wherein the composite content is configured to be displayed on a 3-D display, wherein the composite content is configured to be played back such that the first content and the second content are displayed simultaneously, and wherein the composite content is further configured to be played back such that one of the first content and the second content is displayed appearing in focus and the second one of the first content and the second content is displayed appearing out of focus based on a selection of one of the first content and the second content.

This application claims the benefit of U.S. Provisional Application No. 61/251,052, filed Oct. 13, 2009, which is incorporated in its entirety herein by reference.

### BACKGROUND OF THE INVENTION

1. Field of the Invention

The present invention relates generally to displaying content, and more specifically to multiview display of content.

2. Discussion of the Related Art

Traditional multiview displays are implemented in 2 dimensional display spaces such as picture by picture, picture in picture, picture on picture and tiled pictures. These technique allow a user to view more than one program simultaneously but in general they sacrifice the resolution of the picture by scaling down or occluding part of some or all of the content.

### SUMMARY OF THE INVENTION

Several embodiments of invention provide a method comprising receiving a first content and a second content, applying a first depth to the first content, applying a second depth to the second content and compositing the first content and the second content to generate a 3-Dimensional (3-D) composite content, wherein the composite content is configured to be displayed on a 3-D display wherein the composite content is configured to be played back such that the first content and the second content are displayed simultaneously, and wherein the composite content is further configured to be played back such that one of the first content and the second content is displayed appearing in focus and the second one of the first content and the second content is displayed appearing out of focus based on a selection of one of the first content and the second content.

In another embodiment, the invention can be characterized as an apparatus comprising a content detection module configured to receive a first content and a second content, a depth assignment module configured to apply depth to each of the first content and the second content, a compositor module configured to composite the first content and the second content to generate a 3-Dimensional (3-D) composite content, wherein the composite content is configured to be displayed on a 3-D display such that the first content and the second content are displayed simultaneously, and wherein the composite content is further configured to be played back such that one of the first content and the second content is displayed appearing in focus and the second one of the first content and the second content is displayed appearing out of focus based on a selection of one of the first content and the second content.

In a further embodiment, the invention may be characterized as a system comprising, means for receiving a first content and a second content, means for applying a first depth to the first content, means for applying a second depth to the second content and means for compositing the first content and the second content to generate a 3-Dimensional (3-D) composite content, wherein the 3-D composite content may be played back on a 3-D display to display the first content and the second content simultaneously, and wherein one or the first content and the second content is in focus and the second one of the first content and the second content is out of focus based on a viewer selection.

### BRIEF DESCRIPTION OF THE DRAWINGS

The above and other aspects, features and advantages of several embodiments of the present invention will be more apparent from the following more particular description thereof, presented in conjunction with the following drawings.

FIG. 1 illustrates a method for displaying multiple contents on a 3D display according to several embodiments of the present invention.

FIG. 2 illustrates a signal processing unit for generating a 3D composite content according to several embodiments of the present invention.

FIG. 3 illustrates a system diagram demonstrating the process flow of generating a multiview 3D composite content according to several embodiments of the present invention.

FIG. 4 illustrates an apparatus or system that may be used for implementing any of the methods, apparatuses, and/or modules described according to several embodiments of the present invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

The following description is not to be taken in a limiting sense, but is made merely for the purpose of describing the general principles of exemplary embodiments. The scope of the invention should be determined with reference to the claims.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, etc., to provide a thorough understanding of embodiments of the invention. One skilled in the relevant art will recognize, however, that the invention can be practiced without one or more of the specific details, or with other methods, components, materials, and so forth. In other instances, well-known structures, materials, or operations are not shown or described in detail to avoid obscuring aspects of the invention.

Traditional multiview displays are implemented in 2 dimensional display space such as picture by picture, picture in picture, picture on picture and tiled pictures. These techniques allow a user to view more than one program simultaneously but they all in general sacrifice the resolution of the content by scaling down the content occluding or the content

In some embodiments, the system of the current invention provides a method of enabling multiple multimedia content such as video, streaming content and images to share the same display by placing such content in 3 dimensional space. This new technique can be combined with the conventional 2 dimensional multiview technology as well. In some embodiments, by employing the methods and systems described throughout the present application the limitation of the conventional 2 dimensional multiview displays such as loss of resolution and loss of partial content may be overcome.

3D displays are designed to receive 3D video signals and provide 3D image perception to the viewers. In some embodiments, by providing an appropriate signal processing unit the 3D display can take multiple 2D multimedia content and display them simultaneously without sacrificing the image resolution or occlusion.

For example, in one embodiment, the 3D display may receive two independent 2D content, such as video, images, or other multimedia content. In embodiment the content is produced in a streaming format. According to one embodiment, each of the 2D content is in full resolution but with different level of artificial parallax or other depth value applied. This makes each image appear different in depth. Accordingly, the viewer is able to change focusing on either one of the content that is of interest to that viewer. In one embodiment, each of the content may comprise an images, video, audio or other multimedia content that is distinct and independent from one another. In another embodiment, informational images such as subtitles, closed caption, current time, title and explanation of the program and so on, may be presented along with the multimedia content associated with the information. In such embodiments, the information may be processed with the different level of parallax and/or depth than the main content so that the information can be presented such that it appears to float above the main content or sunk behind the main content.

In one embodiment, the above-mentioned multiview display is provided by a signal processing unit that sits before the 3D image display. In an embodiment, the 3D display takes right-eye video signal and left-eye video signal or a signal that is multiplexed with right-eye video and left-eye video. The subject signal processing unit takes multiple 2D content or menu information and combines the content and/or menu information in the 3D world and generates a signal displayable by the 3D display.

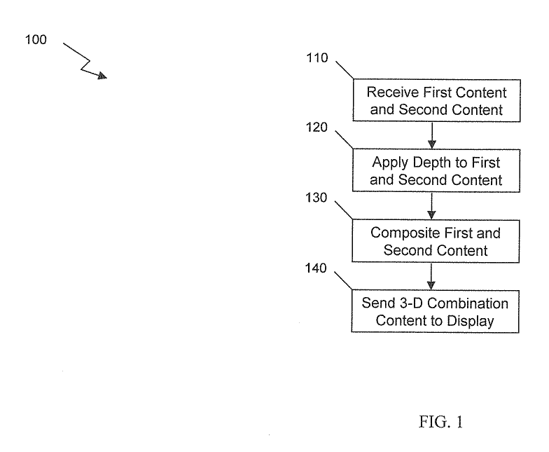

Referring first to FIG. 1, a method 100 is illustrated for displaying multiple contents on a 3D display. In one embodiment, the method begins in step 110 where a first content and second content are received at the signal processing unit. In one or more embodiments, content refers to the data signal corresponding to the content. In one embodiment, the signal processing unit is located at the 3D display, and the 3D display may compromise a multi input receiver for receiving the first content and second content. In another embodiment, the signal processing unit is a separate unit that is communicationally coupled to the 3D display. In such embodiments, the signal processing unit may compromise a multi-input receiver for receiving the first content and second content. In one embodiment, the content is received based on a user selection. In one exemplary embodiment, two content are received in step 110. However, in other embodiments three or more content may be received. It should be understood by one of ordinary skill in the art that more than two contents may be combined and displayed on the 3D display according to the same process as is described herein with respect to the first content and second content. The first content and second content are used herein for exemplary purposes and should not be interpreted as to limit the scope of this invention. In one embodiment, at the time of being received at the 3D display and/or the signal processing unit the two or more content are at an original resolution. In one embodiment, the first content and/or second content comprises 2D images, video, and/or other multimedia content. In another embodiment, one or both the first content and the second content may comprise menu information corresponding to the other one of the first content and second content. In yet another embodiment, one or both of the first content and second content may comprise 3D content, such as 3D image, 3D video content and/or 3D menu information.

Next, in step 120, depth is applied to the first content and second content at the signal processing unit. In one embodiment, the depth application is done by applying different parallax to each of the first content and second content such that each content appears at a unique depth. In one embodiment, the depth assignment is performed in step 120 such that each of the first content and second content may form a different layer of a 3D displayable image.

The process then continues to step 130 where the first content and second content are composited into a single 3D content. In one embodiment, in this step a compositor receives the first content and the second content and composites the first content and the second content based on their assigned depth and/or parallax value to generate a composited 3D content. In one embodiment, the 3D content comprises both the first content and the second content each placed at their assigned depth. In one embodiment, each of the first content and the second content is corn posited such that each content remains at its original resolution within the composited 3D content.

In one embodiment, the compositing comprises alpha blending the first content and the second content. In one embodiment for example, the signal processing unit comprises an alpha blender that receives the first content and second content and their corresponding depth and/or parallax values and composites the first content and the second content according to their assigned depth by alpha blending the content to produce a 3D displayable content that includes both the first content and the second content at their original resolution.

In one embodiment, the data compositing is performed using a weight assigned to one or both the first content and the second content. For example, a weight value may be provided corresponding to the weight or ratio of each content within the final 3D displayable content. In one embodiment, a transparency value may be assigned to each of the first content and the second content. In one embodiment, where an alpha blender is used, the alpha value of the alpha blender may be variable to generate an image having specific characteristics such as the final weight and or transparency of each of the first content and the second content within the final 3D displayable image.

In one embodiment, the compositing module 230 may comprise an alpha blender. In one embodiment the alpha blender generates the 3D content by alpha blending the first content and the second content based on the depth value of the first content and the second content and according to a specific alpha value. An alpha value represents the transparency of each of the first content and the second content within the final 3D content. In some embodiments, alpha values range from 0.0 to 1.0 where 0.0 represents a fully transparent content, and 1.0 represents a fully opaque content. In one embodiment, both the first content and the second content are equally represented in the 3D content, and the alpha value is set accordingly. In some embodiments, this may represent the default alpha value. In one or more embodiments, the alpha blender may receive input to vary the alpha value as to generate the composited 3D content such that one content is represented more transparent than the other. For example, in one embodiment a user may be able to enter a desired alpha value at the user input device 270. The input may be received at the user input interface module and sent to the compositor module, i.e. alpha blender.

Next, in step 140 the 3D content is sent to a 3D display to be displayed to a user. In one embodiment, the 3D display may comprise a glassless 3D display. In another embodiment the 3D display may comprise a display where a user needs 3D glasses. It should be understood to the user that any type of 3D display that is currently available or may become available in the future may be used in the embodiments of the present invention. In some embodiments, the signal processing unit may be programmed to generated 3D images that may be displayed at a specific 3D display or may be generated such that it is universally displayable on all 3D displays.

In one embodiment, once displayed, the user is able to view the first content and the second content simultaneously and at their original resolution. The user may then choose to focus on one of the first content and the second content within the 3D display. When the user selects which content to focus on that content will be display in focus to the user while the other content will be displayed as a double image and/or out of focus to the user. For example, in some embodiments, When the user selects which content to focus on, that content will be perceived in focus to the user while the other content will be perceived as a double image and/or out of focus to the user. In such embodiments, the user's selective focusing discriminates the first content and the second content such that one of the first content and the second content appears and is displayed in focus while the other content will appear and be displayed out of focus and or as a double image to the user. In another embodiment, where one of the first content and the second content comprises the menu information the menu information may appear to be floating on top of the main content. In one embodiment, the user is free to switch between the first content and the second content as the content is being displayed on the 3D display. For example, in one embodiment the user may switch from focusing on the first content and second content by shifting focus from the in-focus content to the out-of-focus content.

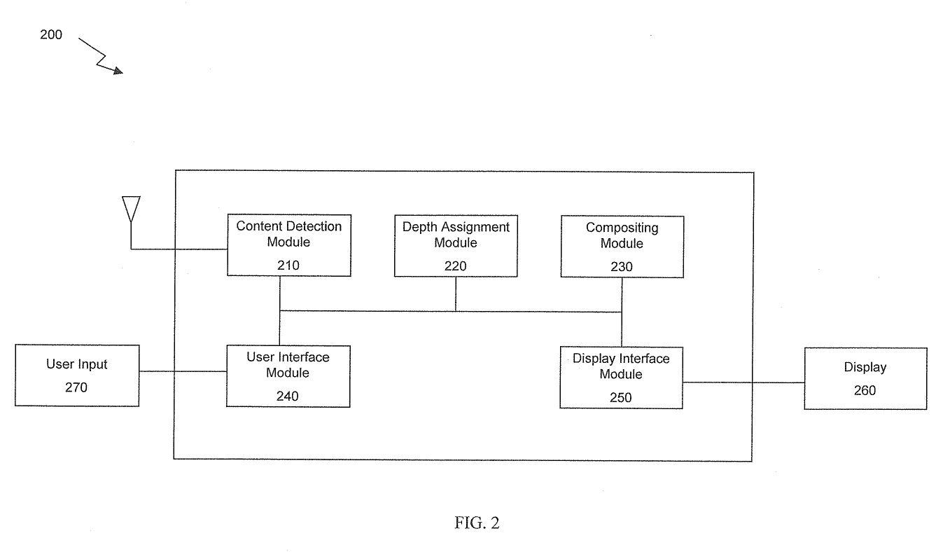

Referring next to FIG. 2, a signal processing unit 200 for generating a 3D displayable content according to several embodiments of the present invention is illustrated. As illustrated, the system comprises a content detection module 210, a depth assignment module 220, a compositing module 230, a user interface module 240, and a display interface module 250 being communicationally coupled by a data bus and/or other connection means. In one or more embodiments, the signal processing unit 200 further comprises a display 260 and one or more user input devices 270. In one or more embodiments, the display 260 and the one or more user input devices 270 are external to the signal processing unit 200 and are connected to the signal processing unit 200 either by a wire or wirelessly. In one embodiment the display 260 is communicationally coupled to the display interface module 250. In one embodiment, the user input device 270 is communicationally coupled to the user interface module 240.

In one embodiment, the content detection module 210 comprises a multi input receiver and/or transceiver for receiving one or more content. According to several embodiments, the content detection module 210 receives the first content and the second content.

In one embodiment, the depth assignment module 220 comprises a processor and/or microcontroller and is able to receive the content from the content detection module 210 and assign a depth and/or parallax value to the content. In one embodiment, the depth assignment module 220 may further be in communication with the user input interface module and the user input devices 270 for receiving desired depth values and or other information. In one embodiment, the depth assignment module 220 may receive the content from the content detection module 210 and may apply the assigned depths to each of the content. In another embodiment, the depth assignment module 220 may simply generate depth values for each of the first content and the second content.

The compositing module 230, according to several embodiments, comprises a compositor for compositing or combining content according to the depth and/or parallax values assigned to each of the first content and the second content. In one embodiment, the compositing module 230 may be communicationally coupled to the content detection module 210 and may directly receive the first content and the second content from the content detection module 210 and may further receive the depth values for the content separately from the depth assignment module 220. In another embodiment, the first and second content along with their corresponding depth values are received from the depth assignment module 220. In one embodiment, the compositing module 230 may further receive other information such as a desired weight, transparency and or other information. Fore example, in one embodiment such information may be received from the user interface module 240. In one embodiment, the compositing module 230 is configured to composite the first content and the second content according to the depth values and optionally, weight, transparency or other such values to generate a 3D content that may be displayed on a 3D display 260. In one embodiment, the compositing module 230 receives the first content and the second content at a first original resolution. In some embodiments, the compositing comprises generating the 3D final content such that it includes the first content and the second content in the same resolution in which they were received.

In one embodiment, the compositing module 230 may comprise an alpha blender. In one embodiment the alpha blender generates the 3D content by alpha blending the first content and the second content based on the depth value of the first content and the second content and according to a specific alpha value. An alpha value represents the transparency of each of the first content and the second content within the final 3D content. In some embodiments, alpha values range from 0.0 to 1.0 where 0.0 represents a fully transparent content, and 1.0 represents a fully opaque content. In one embodiment, both the first content and the second content are equally represented in the 3D content, and the alpha value is set accordingly. In some embodiments, this may represent the default alpha value. In one or more embodiments, the alpha blender may receive input to vary the alpha value as to generate the composited 3D content such that one content is represented more transparent than the other. For example, in one embodiment a user may be able to enter a desired alpha value at the user input device 270. The input may be received at the user input interface module and sent to the compositor module, i.e. alpha blender.

The display interface module 250 is in communication with the compositing module 230 and is configured to receive the 3D content and transmit the content to a 3D display for being displayed to a viewer. In one embodiment, the display interface module 250 may perform one or more preparatory actions to prepare the 3D content received from the compositing module 230.

The user input module may comprise Furthermore, one or more of buttons, keyboard, mouse, joystick, etc. The 3D display may comprise any display that is capable of displaying 3D content. In one embodiment for example, the 3D display may use one or more of several 3D display technologies, and may comprise one or more of a stereoscopic, auto-stereoscopic, hologram and/or volumetric display.

In one or more embodiments the 3D display is configured to display the 3D content based on the selection of one of the first content and second content, wherein the one of the first content and the second content is displayed in focus and the other one of the first content and the second content is displayed simultaneously out of focus. In one embodiment, the selection is performed by a user focusing on one of the first content and the second content. For example, in some embodiments, When the user selects which content to focus on, that content will be perceived in focus to the user while the other content will be perceived as a double image and/or out of focus to the user. In such embodiments, the user's selective focusing discriminates the first content and the second content such that one of the first content and the second content appears and is displayed in focus while the other content will appear and be displayed out of focus and or as a double image to the user. For example, when the content is simultaneously displayed the user may focus on the first content being displayed and the first content will accordingly appear in focus to the user while the second content is displayed simultaneously out of focus. The user may then switch focus to the second content and the second content will appear in focus, and the first content will appear out of focus. If more than two contents are contained within the 3D module, the same results will be achieved when the user focuses on any of the two or more contents, and the remaining contents will appear out of focus.

In one embodiment, the 3D display may be in communication with the 3D display interface module 250 and/or the signal processing unit 200 by way of a wire or wirelessly. In another embodiment, the signal processing unit 200 is located at the 3D display device. It should be noted that one or more of the elements of the signal processing unit 200 may be combined into a single module and may perform the functions as described with respect to each of the elements.

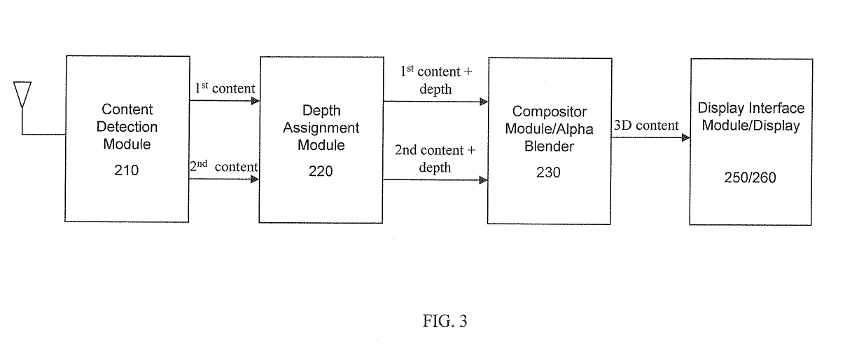

Referring next to FIG. 3, a system diagram is illustrated demonstrating the interconnections and process flow according to several embodiments of the present invention. In one embodiment, the signal processing method of the present invention begins when two or more content signals are received at the content detection module 210. In one embodiment, the content detection module 210 receives a first content and a second content. In another embodiment the content detection module 210 may receive three or more contents. The content may comprise 2D content or 3D content. In one embodiment, the content detection module 210 comprises a channel selection module for tuning into a channel providing the content. For example, in one embodiment, the user may select to receive the two or more content and the content detection module 210 will tune into the selected channels to retrieve the requested content. When the content is received, the content detection module 210 may further perform additional actions on the content to prepare the content for the depth assignment module 220, or may simply pass the content to the depth assignment module 220.

According to one or more embodiments, the content detection module 210 then forwards the first content and the second content to the depth assignment module 220, where a depth and/or parallax value is assigned to each of the first content and the second content. In one embodiment the depth value may define a relationship between the first content and the second content in terms of their position relative to one another from a near plane to a far plane. In another embodiment, the depth values may be default values that are assigned to any content that is assigned a depth value. In yet another embodiment, the user may select the depth values that are assigned to the first content and the second content. In one or more embodiments the depth value compromises an artificial parallax that is assigned to each of the content.

Next, the first content and the second content along with the assigned depth values are forwarded to the compositing module 230 where the first content and the second content is composited to generate a 3D displayable content. As described above, the first content and the second content are composited according to their depth values to create a 3D displayable content. In one embodiment, the compositing module 230 may have the capability to create several types of 3D displayable content to account for different types of 3D displays such that it can be used with and be compatible with any 3D display available. In one embodiment, the compositing module 230 may be configured to create the 3D content that is compatible with the display that is connected to the unit at the time of installation and configuration of the signal processing unit 200. In another embodiment, the composting module may receive input to determine the type of 3D content that should be generated and will be compatible with the display. In one embodiment the 3D displayable composited content is generated such that it comprises the first content and the second content in the same resolution in which they were received.

The 3D displayable content is next forwarded to the display to be displayed to the user. As described above, the display device may be in communication with the compositing module 230 through a display interface module 250. For example, in one embodiment, the display interface module 250 receives the generated 3D content and prepares the 3D content for being displayed at a 3D display device 260. In another embodiment, the display may have capability to configure the content for being displayed. In one embodiment the 3D display is configured for displaying the composite content based on the selection of one of the first content and second content, wherein the selected one of the first content and the second content is displayed in focus and the other one of the first content and the second content is displayed simultaneously out of focus. The selection may be performed by the user choosing to focus on one of the first content and the second. For example, in some embodiments, When the user selects which content to focus on, that content will be perceived in focus to the user while the other content will be perceived as a double image and/or out of focus to the user. In such embodiments, the user's selective focusing discriminates the first content and the second content such that one of the first content and the second content appears and is displayed in focus while the other content will appear and be displayed out of focus and or as a double image to the user. In other embodiments, other methods may be employed to select which of the content is displayed in focus.

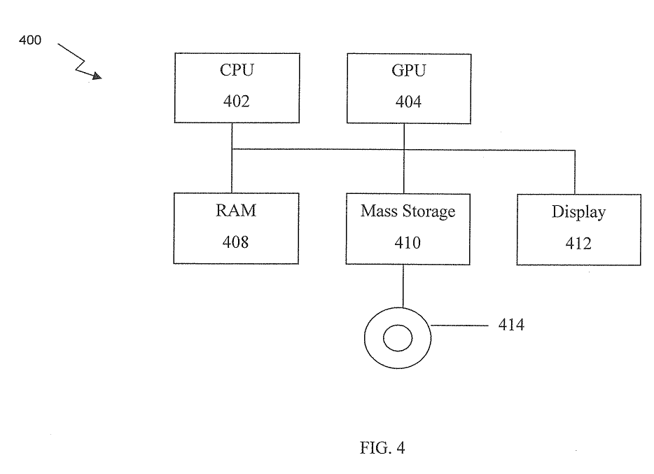

Referring to FIG. 4, there is illustrated an apparatus or system 400 that may be used for implementing any of the methods, apparatuses, and/or modules described according to several embodiments of the present invention. One or more components of the apparatus or system 400 may be used for implementing any system or device mentioned above, such as for example any of the above-mentioned displays, signal processing units, modules, input devices, etc. However, the use of the apparatus or system 400 or any portion thereof is certainly not required.

By way of example, the apparatus or system 400 may include, but is not required to include, a central processing unit (CPU) 402, a graphics processing unit (GPU) 404, a random access memory (RAM) 408, and a mass storage unit 410, such as a disk drive or other type of memory. The apparatus or system 400 may be coupled to, or integrated with, any of the other components described herein, such as a display 412. The apparatus or system 400 comprises an example of a processor based apparatus or system. The CPU 402 and/or GPU 404 may be used to execute or assist in executing the steps of the methods and techniques described herein, and various program content, images, etc. may be rendered on the display 412.

The mass storage unit 410 may include or comprise any type of computer readable storage or recording medium or media. The computer readable storage or recording medium or media may be fixed in the mass storage unit 410, or the mass storage unit 410 may optionally include removable storage media 414, such as a digital video disk (DVD), Blu-ray disc, compact disk (CD), USB storage device, floppy disk, or other media. By way of example, the mass storage unit 410 may comprise a disk drive, a hard disk drive, flash memory device, USB storage device, Blu-ray disc drive, DVD drive, CD drive, floppy disk drive, etc. The mass storage unit 410 or removable storage media 414 may be used for storing program code or macros that implement the methods and techniques described herein.

Thus, removable storage media 414 may optionally be used with the mass storage unit 410, which may be used for storing program code that implements the methods and techniques described herein. However, any of the storage devices, such as the RAM 408 or mass storage unit 410, may be used for storing such program code. For example, any of such storage devices may serve as a tangible computer readable storage medium for storing or embodying a computer program for causing a console, system, computer, or other processor based system to execute or perform the steps of any of the methods, code, and/or techniques described herein. Furthermore, any of the storage devices, such as the RAM 408 or mass storage unit 410, may be used for storing any needed database(s).

In some embodiments, one or more of the embodiments, methods, approaches, and/or techniques described above may be implemented in a computer program executable by a processor based system. By way of example, such processor based system may comprise the processor based system 400, or a computer, entertainment system, game console, graphics workstation, etc. Such computer program may be used for executing various steps and/or features of the above-described methods and/or techniques. That is, the computer program may be adapted to cause or configure a processor based system to execute and achieve the functions described above. For example, such computer program may be used for implementing any embodiment of the above-described steps or techniques for enabling the user to view multiple contents on a single display by generating a 3D displayable content. As another example, such computer program may be used for implementing any type of tool or similar utility that uses any one or more of the above described embodiments, methods, approaches, and/or techniques. In some embodiments, program code macros, modules, loops, subroutines, etc., within the computer program may be used for executing various steps and/or features of the above-described methods and/or techniques. In some embodiments, the computer program may be stored or embodied on a computer readable storage or recording medium or media, such as any of the computer readable storage or recording medium or media described herein.

In some embodiments, a processor-based apparatus may be used for executing or performing any of the above-described steps, methods, and/or techniques.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions that may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

While the invention herein disclosed has been described by means of specific embodiments, examples and applications thereof, numerous modifications and variations could be made thereto by those skilled in the art without departing from the scope of the invention set forth in the claims.

What is claimed is:

1. A method comprising:
receiving a first content and a second content;
applying a first depth to the first content;
applying a second depth to the second content; and
compositing the first content and the second content to generate a 3-Dimensional (3-D) composite content, wherein the composite content is configured to be displayed on a 3-D display; and
wherein the composite content is configured to be played back such that the first content and the second content are displayed simultaneously, and wherein the composite content is further configured to be played back such that one of the first content and the second content is displayed appearing in focus and the second one of the first content and the second content is displayed appearing out of focus based on a selection of one of the first content and the second content.

2. The method of claim 1, wherein one or both the first content and the second content comprise 2-Dimensional (2-D) content.

3. The method of claim 1, wherein one or both the first content and the second content comprise 3-D content.

4. The method of claim 1 further comprising sending the composite content to a display capable of displaying 3-D content.

5. The method of claim 1, wherein the first content and the second content comprise one of a streaming video, digital image, or menu information.

6. The method of claim 1, further comprising:
receiving a third content;
applying a third depth to the third content;
wherein the compositing further comprises compositing the third content with the first content and the second content to form the composite content.

7. The method of claim 1, wherein the compositing comprises generating the composite content such that it includes the first content and the second content in the same resolution that they were received.

8. The method of claim 1, wherein the compositing comprises alpha blending the first content and the second content based on an alpha value.

9. The method of claim 8 wherein the alpha value is varied based on a user selection.

10. The method of claim 1 further comprising displaying the composite content based on the selection of one of the first content and the second content, wherein the one of the first content and the second content having been selected is displayed appearing in focus and the other one of the first content and the second content is displayed simultaneously appearing out of focus.

11. An apparatus comprising:
a content detection module configured to receive a first content and a second content;
a depth assignment module configured to apply depth to each of the first content and the second content;
a compositor module configured to composite the first content and the second content to generate a 3-Dimensional (3-D) composite content, wherein the composite content is configured to be displayed on a 3-D display such that the first content and the second content are displayed simultaneously, and wherein the composite content is further configured to be played back such that one of the first content and the second content is displayed appearing in focus and the second one of the first content and the second content is displayed appearing out of focus based on a selection of one of the first content and the second content.

12. The apparatus of claim 11, further comprising an interface module, configured to send the composite content to a 3-D display for playback of the composite content.

13. The apparatus of claim 11 wherein the compositor module comprises an alpha blender.

14. The apparatus of claim 11, further comprising a 3-D display module configured to display the 3-D content based on the selection of one of the first content and the second content, wherein the one of the first content and the second content having been selected is displayed appearing in focus and the other one of the first content and the second content is displayed simultaneously appearing out of focus.

15. The apparatus of claim 11 further comprising a user interface module configured to receive user input.

16. The apparatus of claim 15, wherein the user input comprises one or more of a content selection, depth selection and alpha value selection.

17. A system comprising:
means for receiving a first content and a second content;
means for applying a first depth to the first content;
means for applying a second depth to the second content; and
means for compositing the first content and the second content to generate a 3-Dimensional (3-D) composite content, wherein the 3-D composite content may be played back on a 3-D display to display the first content and the second content simultaneously, and wherein one or the first content and the second content is in focus and the second one of the first content and the second content is out of focus based on a viewer selection.
